(19) United States
(12) Patent Application Publication
(10) Pub. No.: US 2019/0386986 A1
(43) Pub. Date: Dec. 19, 2019

(54) SYSTEM AND METHOD FOR AUTOMATED VEHICLE AUTHENTICATION

(71) Applicant: Walmart Apollo, LLC, Bentonville, AR (US)

(72) Inventors: John J. O'Brien, Farmington, AR (US); Donald R. High, Noel, MO (US); Brian G. McHale, Chadderton Oldham (GB); David C. Winkle, Bella Vista, AR (US); Samantha M. Mangosing, Rogers, AR (US)

(21) Appl. No.: 16/435,798

(22) Filed: Jun. 10, 2019

Related U.S. Application Data
(60) Provisional application No. 62/686,272, filed on Jun. 18, 2018.

(51) Int. Cl. H04L 29/06; G06Q 10/08; G07C 5/00; G05D 1/02; B64C 39/02

(52) U.S. Cl. CPC H04L 63/0853; G06Q 10/08355; B64C 2201/128; G05D 1/0225; B64C 39/024; G07C 5/008

(57) ABSTRACT

An analysis of the delivery characteristics of an automated vehicle and a comparison of received security credentials of the vehicle to acceptable credentials are performed. Based upon the results of the analysis and the comparison, a confidence score is determined. The confidence score is a numerical measure of trust in an authentic identity of the automated vehicle. The determined confidence score is compared to the confidence threshold and when the score exceeds the confidence threshold, a message is transmitted to the automated vehicle allowing the vehicle to deliver a package to a delivery location.

### CROSS-REFERENCE TO RELATED APPLICATION

This application claims the benefit of the following U.S. Provisional Application No. 62/686,272 filed Jun. 18, 2018, which is incorporated herein by reference in its entirety.

### TECHNICAL FIELD

These teachings relate to the authentication of automated vehicles and, more specifically, to the authentication of automated vehicles making deliveries.

### BACKGROUND

Various types of automated delivery vehicles make various types of deliveries. For example, aerial drones or automated ground vehicles may deliver packages to homes or businesses.

When the vehicle is approaching its destination, it may be required to receive permission to land or proceed. For instance, an aerial drone may send a communication requesting to land, and permission may be granted or denied by a ground controller.

Some problems may occur when permission to deliver is granted, but when permission should not have been granted. For example, situations may occur when too many packages are waiting in the delivery area and no more packages should be delivered. In this situation, there may not be enough space in the delivery area for additional packages, and packages may become damaged, lost, or stolen if permission for delivery is granted.

In another situation, the package may be from a nefarious actor, and delivery may result in harm to those present at the delivery area. In this case, delivery of the package may result in harm to those persons at the delivery location. In these situations, it is not desirable to grant permission to make the delivery.

### BRIEF DESCRIPTION OF THE DRAWINGS

The above needs are at least partially met through the provision of approaches that authentication of automated vehicles, wherein:

FIG. 1 comprises a diagram of a system as configured in accordance with various embodiments of these teachings;

FIG. 2 comprises a diagram of a system as configured in accordance with various embodiments of these teachings;

FIG. 3 comprises a flowchart as configured in accordance with various embodiments of these teachings;

FIG. 4 comprises a diagram of aspects of a system as configured in accordance with various embodiments of these teachings.

FIG. 5 comprises an illustration of blocks as configured in accordance with various embodiments of these teachings;

FIG. 6 comprises an illustration of transactions configured in accordance with various embodiments of these teachings;

FIG. 7 comprises a flow diagram in accordance with various embodiments of these teachings;

FIG. 8 comprises a process diagram as configured in accordance with various embodiments of these teachings;

FIG. 9 comprises an illustration of a delivery record configured in accordance with various embodiments of these teachings;

FIG. 10 comprise a system diagram configured in accordance with various embodiments of these teachings.

### DETAILED DESCRIPTION

Generally speaking, a system determines whether to accept the delivery of a package from an automated vehicle. At the delivery location, one or more sensors receive or obtain characteristics associated with the vehicle or the delivery. The data obtained by the sensors can be analyzed to ascertain further information. For example, data may indicate movement of the vehicle, and this data is analyzed to see if the movement is suspicious. In another example, identifiers on the vehicle (e.g., a number on the tail of the drone) are observed and a determination is made to determine if there is a match with an expected identifier.

Security credentials are also received and compared to approved credentials on a blockchain ledger stored at the delivery location. Based upon an analysis of the received characteristics and whether the security credentials are approved, a confidence score is determined. If the confidence score exceeds a threshold, then permission is given to the vehicle to deliver the package. The threshold is dynamic and can be adjusted based upon a security level.

In many of these examples, autonomous vehicle delivery verification and authentication using confidence level is provided. In these examples, various criteria are used to establish confidence in accepting a package for delivery by a drone or other automated vehicle.

In other aspects, a configurable threshold value is established at a delivery site. The threshold value may be or represent the level of security desired, for example, high, medium, or low. A confidence level associated with a delivery vehicle may be determined. The confidence level may be based upon whether the automated vehicle is known, whether a validation or authorization is complete, whether the delivery is expected or matches a schedule, whether observable markings on the vehicle match known or expected markings, and/or whether delivery criteria are met. This system works with automated vehicles (e.g., aerial drones or automated ground vehicles) from all sources including vehicles from a known fleet, vehicles of authorized third parties, and unknown vehicles.

In yet other aspects, the present approaches provide for different levels of authentication depending upon the value of the package and the confidence level from factors such as the origin of the package (trusted or untrusted source), trusted drone from within the network, source of package, destination of package, or traveled route of vehicle (e.g., analyze whether the automated vehicle followed the planned route).

In still other aspects, third-party automated vehicles (e.g., drones) obtain and earn trust (as reflected in a confidence level or score) based upon various factors such as whether the drone is from a trusted owner, carrier, or fleet; the number of completed transactions; the insured/bonded carrier; whether the observable markings on the automated vehicle match with expected markings; whether the delivery location is a public or private location (e.g., kiosk); whether the automated vehicle is a private or publicly operated vehicle (e.g., drone); and/or whether the package size, weight, markings match the item file or bill of lading. Other examples of factors are possible.

In yet other aspects, a kiosk may be used as a delivery location and reservation of kiosk space depends upon the confidence level. For example, the confidence score may depend upon the customer's record of picking up items from a kiosk. For example, a determination may be made as to whether the customer picked items up the item promptly. In some examples, the customer is charged if confidence level is low or for extended storage.

In still other aspects, a kiosk system could be used to facilitate product returns and customer-to-customer product sales. For returns to the store that sold the product, the kiosk could segregate the returning items and verify the size, weight, markings match the item as described in an item file or product catalog. The system could also look for an authorization of returns processed by the customer in the system using the mobile applications (apps). The kiosk system could additionally verify the customer information and confidence level before accepting the package for return. In still other examples, customers may rent lockers or kiosk space by the day, week, month or year.

The system may verify that a low confidence level, third-party drone is authentic using a private key and the distributed ledger. In aspects, each drone includes a unique private key with blockchain. Trust could be built over time (e.g., based upon history), built by payment history (e.g., payment for deliveries), or built by insurance (e.g., a performance bond).

As mentioned, kiosks in stores could be used for product returns or exchange and third party buying and selling. The kiosk system would consolidate multiple items or orders into a single bin for enhanced customer experience.

In many of these embodiments, a system is configured to determine whether to accept a delivery of a package from an automated vehicle. The system includes an automated vehicle, at least one sensor, a transceiver circuit, and an authentication and verification device.

The automated vehicle includes a package disposed in a storage bay and is delivering the package to a delivery location. The sensor is disposed at the delivery location and is configured to measure one or more delivery characteristics associated with the delivery. The delivery characteristics relate to one or more of: characteristics relating to movement of the automated vehicle, characteristics relating to identification of the automated vehicle, or characteristics of the package.

The transceiver circuit s disposed at the delivery location that is configured to receive security credentials from the automated vehicle. The authentication and verification device is coupled to the sensor and the transceiver circuit and is disposed at the delivery location.

The authentication and verification device includes a control circuit and a data storage device. The data storage device stores a confidence threshold and the confidence threshold is a numerical value that is dynamically adjustable and related to a security level. The data storage device also stores a blockchain ledger that stores acceptable security credentials.

The control circuit is configured to perform an analysis of the delivery characteristics and perform a comparison of the received security credentials to acceptable credentials on the ledger. Based upon the results of the analysis and the comparison, the control circuit is configured to determine a confidence score. The confidence score is a numerical measure of trust in an authentic identity of the automated vehicle.

The control circuit is further configured to compare the determined confidence score to the confidence threshold and when the score exceeds the confidence threshold, transmit a message to the automated vehicle allowing the vehicle to deliver the package to the delivery location. The vehicle responsively delivers the package to the delivery location.

In examples, the characteristics relating to movement of the automated vehicle comprises one or more of a flight path of the automated vehicle, an altitude of the automated vehicle, a velocity of the automated vehicle, or an on-time performance of the automated vehicle. Other examples are possible.

In aspects, the characteristics relating to identification of the automated vehicle relate to an identifier displayed on the automated vehicle. Other examples are possible.

In still other examples, the characteristics of the package include whether the package has been paid for by a customer and the delivery route. Other examples are possible.

In other aspects, the sensor is a camera, a radar device, or a transceiver circuit. In yet other examples, the delivery location is a kiosk, a retail store, a warehouse, a distribution center. or a customer residence. Other examples are possible.

In still other examples, the system further includes a central computer. The central computer is disposed at a location remote from the delivery location and configured to receive communications from one or more of the automated vehicle or the delivery location, and to determine whether to allow delivery of the package at the delivery location based at least in part upon the communications.

In other aspects, the automated vehicle is an aerial drone or an automated ground vehicle. Other examples of vehicles are possible.

In yet other aspects, the sensed delivery characteristics and the received security credentials are weighted in determining the confidence score. The weighting may be according to the relative importance of the characteristics.

In others of these embodiments, a package is stored in a storage bay of an automated vehicle and the automated vehicle is delivering the package to a delivery location. A sensor that is disposed at the delivery location measures one or more delivery characteristics associated with the delivery. The delivery characteristics relate to one or more of: characteristics relating to movement of the automated vehicle, characteristics relating to identification of the automated vehicle, or characteristics of the package.

At a transceiver circuit disposed at the delivery location, security credentials are received from the automated vehicle. At an authentication and verification device that is disposed at the delivery location, a confidence threshold is stored. The confidence threshold is a numerical value that is dynamically adjustable and related to a security level. The data storage device also stores a blockchain ledger that includes acceptable security credentials.

At an authentication and verification device, an analysis of the delivery characteristics and a comparison the received security credentials to acceptable credentials on the ledger are performed.

At the authentication and verification device and based upon the results of the analysis and the comparison, a confidence score is determined. The confidence score is a numerical measure of trust in an authentic identity of the automated vehicle. The determined confidence score is compared to the confidence threshold and when the score exceeds the confidence threshold, a message is transmitted to the automated vehicle allowing the vehicle to deliver the package to the delivery location. Upon receipt of the message, the vehicle responsively delivers the package to the delivery location.

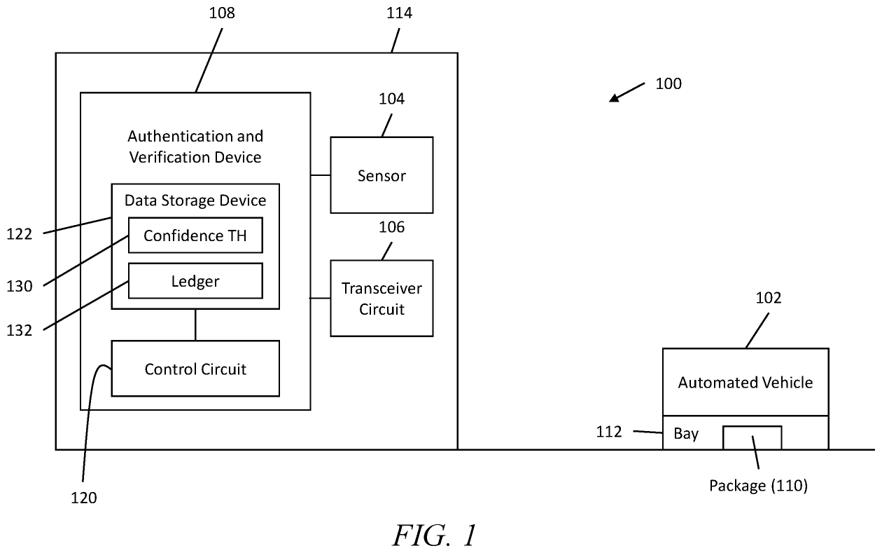

Referring now to FIG. 1, a system 100 configured to determine whether to accept a delivery of a package from an automated vehicle is described. The system 100 includes an automated vehicle 102, at least one sensor 104, a transceiver circuit 106, and an authentication and verification device 108.

The automated vehicle 102 includes a package 110 disposed in a storage bay 112 and is delivering the package 110 to a delivery location 114. The delivery location 114 may be a home, business, school, warehouse, retail store, or distribution center to mention a few examples. The storage bay 112 is any mechanical structure that is configured to hold packages for delivery. The storage bay 112 may be enclosed by doors that open so as to deposit a package. In addition, other mechanisms (e.g., conveyers, lifting arms or mechanisms) can be utilized to remove the package 110 from the vehicle 102.

The sensor 104 is disposed at the delivery location 114 and is configured to measure one or more delivery characteristics associated with the delivery. The sensor 104 may be any type of sensor such as a camera, scanner, motion sensor, laser, radar, lidar, or any other arrangement that is capable of sensing information.

The delivery characteristics relate to one or more characteristics relating to movement of the automated vehicle, characteristics relating to identification of the automated vehicle, or characteristics of the package. Other examples are possible.

The transceiver circuit 106 is disposed at the delivery location 114 that is configured to receive security credentials from the automated vehicle 102. The transceiver circuit 106 is any combination of electronic hardware or computer software that can transmit and/or receive information or data.

The authentication and verification device 108 is coupled to the sensor 104 and the transceiver circuit 106 and is disposed at the delivery location 114. The authentication and verification device 108 includes a control circuit 120 and a data storage device 122.

The data storage device 122 stores a confidence threshold 130 and the confidence threshold 130 is a numerical value that is dynamically adjustable and related to a security level. The data storage device 122 also stores a blockchain ledger 132 (or similar arrangement) that stores acceptable security credentials.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 120 may be configured (for example, by using corresponding programming stored in a memory as will be well understood by those skilled in the art) to carry out one or more of the steps, actions, and/or functions described herein.

The control circuit 120 is configured to perform an analysis of the delivery characteristics and perform a comparison of the received security credentials to acceptable credentials on the ledger. Based upon the results of the analysis and the comparison, the control circuit is configured to determine a confidence score. The confidence score is a numerical measure of trust in an authentic identity of the automated vehicle.

The control circuit 120 is further configured to compare the determined confidence score to the confidence threshold and when the score exceeds the confidence threshold, transmit a message to the automated vehicle 102 allowing the vehicle to deliver the package to the delivery location. The vehicle 102 responsively delivers the package 110 to the delivery location 114.

In examples, the characteristics relating to movement of the automated vehicle comprises one or more of a flight path of the automated vehicle 102, an altitude of the automated vehicle 102, a velocity of the automated vehicle 102, or an on-time performance of the automated vehicle 102. Other examples are possible.

In aspects, the characteristics relating to identification of the automated vehicle relate to an identifier displayed on the automated vehicle 102. Other examples are possible.

In still other examples, the characteristics of the package 110 include whether the package has been paid for by a customer and the delivery route. Other examples are possible.

In yet other examples, the delivery location 114 is a kiosk, a retail store, a warehouse, a distribution center. or a customer residence. Other examples are possible.

In still other examples, the system 100 further includes a central computer. The central computer is disposed at a location remote from the delivery location 114 and configured to receive communications from one or more of the automated vehicle 102 or the delivery location 114, and to determine whether to allow delivery of the package 110 at the delivery location 114 based at least in part upon the communications.

In other aspects, the automated vehicle 102 is an aerial drone or an automated ground vehicle. Other examples of vehicles are possible.

In yet other aspects, the sensed delivery characteristics and the received security credentials are weighted in determining the confidence score. The weighting may be according to the relative importance of the characteristics.

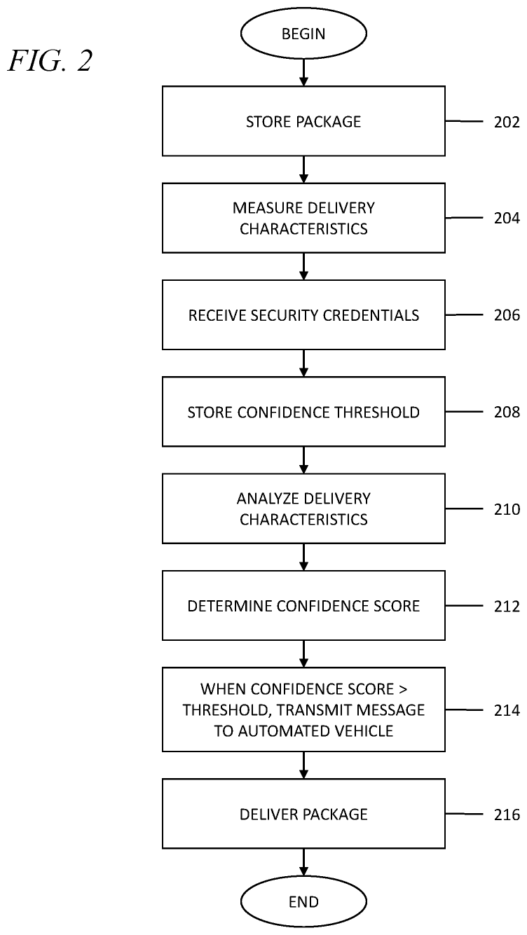

Referring now to FIG. 2 one example of an approach for authenticating deliveries is described. At step 202, a package is stored in a storage bay of an automated vehicle and the automated vehicle is delivering the package to a delivery location. For example, the package may be in the process of being delivered to a retail store, distribution center, warehouse, home, office, or business.

At step 204, a sensor that is disposed at the delivery location measures one or more delivery characteristics associated with the delivery. The delivery characteristics relate to one or more of: characteristics relating to movement (e.g., speed or direction) of the automated vehicle, characteristics relating to identification of the automated vehicle, or characteristics of the package. For example, a camera may be used to obtain images of the drone to obtain markings on the drone or whether the drone is following an expected route or making unexpected or suspicious movements.

At step 206 and at a transceiver circuit disposed at the delivery location, security credentials are received from the automated vehicle. The security credentials may, in examples, identify the drone, the owner of the drone, or transactional information concerning the drone.

At step 208 and at an authentication and verification device that is disposed at the delivery location, a confidence threshold is stored. The confidence threshold is a numerical value that is dynamically adjustable and is related to a security level. The data storage device also stores a blockchain ledger that includes acceptable security credentials.

At step 210 and at the authentication and verification device, an analysis of the delivery characteristics and a comparison the received security credentials to acceptable credentials on the ledger are performed. For example, the identity of the drone may be confirmed by finding the same information on the ledger, which contains a list of known, valid, confirmed drones.

At step 212 and at the authentication and verification device, a confidence score is determined based upon the results of the analysis and the comparison. The confidence score is a numerical measure of trust in an authentic identity of the automated vehicle. As described elsewhere herein, the confidence score may be determined by weighting various factors and then summing the weighted factors to obtain a confidence score.

At step 214, the determined confidence score is compared to the confidence threshold and when the score exceeds the confidence threshold, a message is transmitted to the automated vehicle allowing the vehicle to deliver the package to the delivery location.

At step 216 and upon receipt of the message, the vehicle responsively delivers the package to the delivery location.

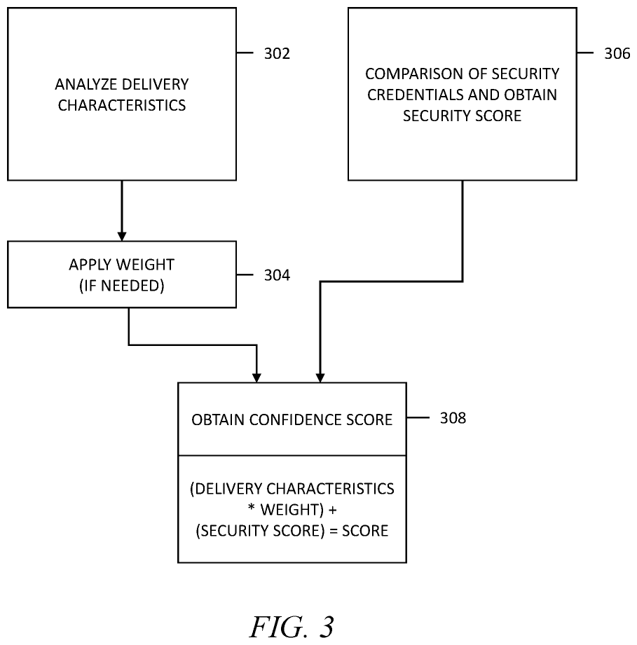

Referring now to FIG. 3, one example of an approach for determining a confidence score is described. At step 302, delivery characteristics are analyzed. For example, it may be determined if a drone is on-time, whether the drone's markings match expected markings, or whether the package is from a trusted source. This information may be obtained from sensors (e.g., a camera that obtains an image of the markings on the drone) or from other automated sources. The information may also be entered manually (e.g., a performance bond of a carrier or delivery service may be scanned).

At step 304, weights may be associated with these characteristics and a characteristic sub-score obtained. For example, it may be determined that it is of greater importance that the drone is flying an expected route rather than the package is from a trusted source. For example, assume there are three characteristics (on-time, trusted source, traveling expected route). Assume that characteristics are weighted as follows: on-time is given a 0.5 weighting factor, being a trusted source is given a 0.1 weighting factor, and traveling an expected route is given a 0.4 weighting factor. In a particular case, assume the drone is on-time, and from a trusted source, but not flying the expected route. Thus, the characteristic score is 0.5+0.1+0=0.6.

At step 306, a comparison is made between the security credentials from the drone and those on the blockchain to obtain a security score. A security score is 1.0 if there is a match, while the security score is 0.0 if there is no match. In aspects, a match occurs when security credentials of the drone are also present on the blockchain.

At step 308, the (overall) confidence score is obtained. A first overall weighing factor may be applied to the characteristic score, and a second applied to the security score, and the two factors totaled to obtain the confidence score. Assume that the first weighting (for the characteristic score) is 0.4 and the second weighting (for the security score) is 0.6. In this example, assuming a match of security certificates (security score=1), assuming characteristic score of 0.6, then the confidence score is (0.4)*(0.6)+(0.6)*(1)=0.24+0.6=0.84.

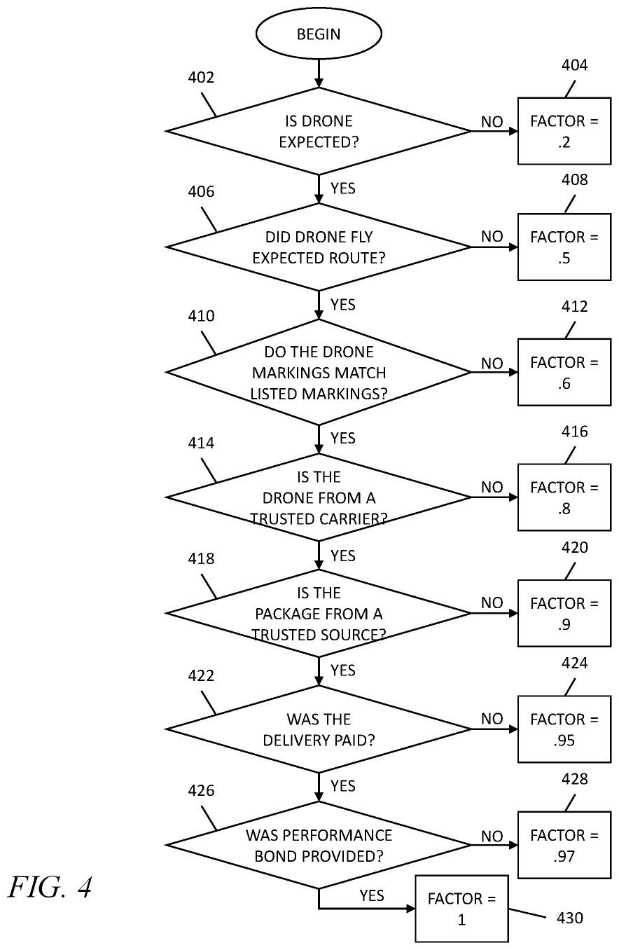

Referring now to FIG. 4, one example for determining a confidence score or factor is described. It will be appreciated that the approach described with respect to FIG. 4 is one example and that other examples are possible.

At step 402, it is determined if the drone is expected. For example, the authentication and verification device of FIG. 1 may store or obtain information that indicates that the drone is in route to the destination. If the answer is negative, at step 404 the score or factor is set to 0.2. If the answer is affirmative, then execution continues at step 406.

At step 406, it is determined if the drone has taken the expected route. For example, the authentication and verification device of FIG. 1 may store or obtain information that identifies the route that the drone is taking. The authentication and verification device may obtain information that tracks movement of the drone (e.g., images from a camera, radar information, information from a GPS tracking service that tracks the location of the drone). If the answer is negative, at step 408 the score or factor is set to 0.5. If the answer is affirmative, then execution continues at step 410.

At step 410, it is determined if the markings on the drone match the expected markings. For example, the authentication and verification device of FIG. 1 may obtain, from cameras, images of the drone that include images of markings on the drone as the drone approaches. The authentication and verification device may compare these markings with those stored at the authentication and verification device. In other examples, verified markings may be stored at the ledger. A comparison is made by the authentication and verification device to see if there is a match. If the answer is negative, at step 412 the score or factor is set to 0.6. If the answer is affirmative, then execution continues at step 414.

At step 414, it is determined if the drone is from a trusted carrier. For example, the authentication and verification device may store information indicating that the carrier operating the drone is trusted (e.g., from a certificate or from a record of the operation of the carrier). If the answer is negative, at step 416 the score or factor is set to 0.8. If the answer is affirmative, then execution continues at step 418.

At step 418, it is determined if the package is from a trusted source. For example, authentication and verification device may store information indicate which sources (e.g., customers, businesses, suppliers, to mention a few examples) are trusted. If the answer is negative, at step 420 the score or factor is set to 0.9. If the answer is affirmative, then execution continues at step 422.

At step 422, it is determined if the delivery has been paid. For example, authentication and verification device may obtain information from the carrier or package source that the package delivery has been paid. If the answer is negative, at step 424 the score or factor is set to 0.95. If the answer is affirmative, then execution continues at step 426.

At step 426, it is determined if a performance bond has been provided. For example, the authentication and verification device may store or obtain information that a performance bond exists. If the answer is negative, at step 428 the score or factor is set to 0.97. If the answer is affirmative, then execution continues at step 430 where the score or factor is set to 1.0.

It will be appreciated that as the affirmative answers accumulate in the example of FIG. 4, the confidence score relating to these factors is increased. It will also be appreciated that these examples may obtain a “characteristic score” which can have a weighting applied, and then summed with a weighted security score (whether security credentials of the drone were verified) to obtain an overall confidence score. In still other examples,

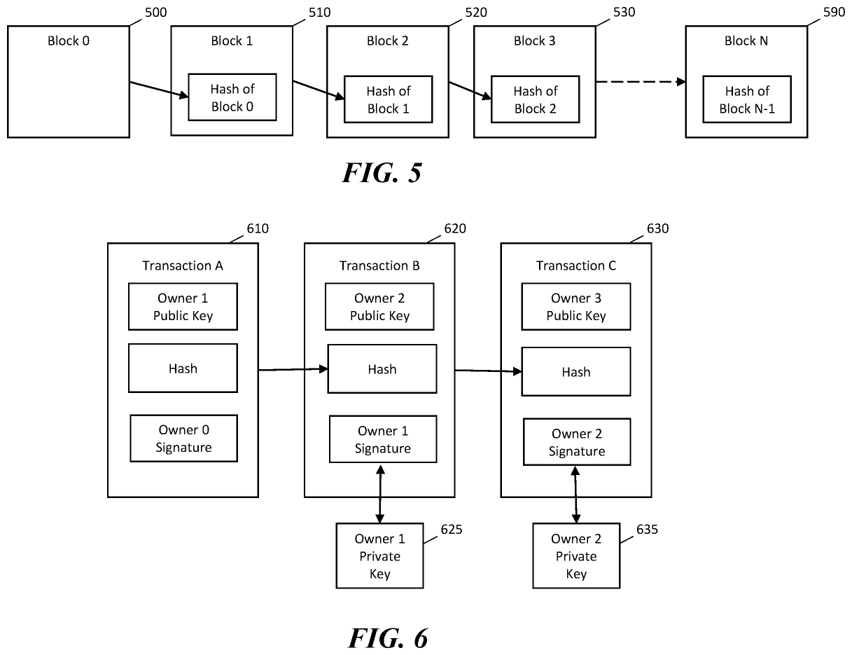

It will be appreciated that, in aspects, the present approaches utilize blockchain technology to verify the security credentials of the drone or automated vehicle. Descriptions of some embodiments of blockchain technology are provided with reference to FIGS. 5-10 herein. In some embodiments of the invention described above, blockchain technology may be utilized to record security certificates or other identification information. One or more of the delivery locations described herein may comprise a node in a distributed blockchain system storing a copy of the blockchain record. Updates to the blockchain may comprise the addition of security certificates and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes (e.g., delivery locations) configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 5, an illustration of a blockchain according to some embodiments is shown. In some embodiments, a blockchain comprises a hash chain or a hash tree in which each block added in the chain contains a hash of the previous block. In FIG. 5, block 0 500 represents a genesis block of the chain. Block 1 510 contains a hash of block 0 500, block 2 520 contains a hash of block 1 510, block 3 530 contains a hash of block 2 520, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

Now referring to FIG. 6, an illustration of blockchain based transactions according to some embodiments is shown. In some embodiments, the blockchain illustrated in FIG. 6 comprises a hash chain protected by private/public key encryption. Transaction A 610 represents a transaction recorded in a block of a blockchain showing that owner 1 (recipient) obtained an asset from owner 0 (sender). Transaction A 610 contains owner's 1 public key and owner 0's signature for the transaction and a hash of a previous block. When owner 1 transfers the asset to owner 2, a block containing transaction B 620 is formed. The record of transaction B 620 comprises the public key of owner 2 (recipient), a hash of the previous block, and owner 1's signature for the transaction that is signed with the owner 1's private key 625 and verified using owner 1's public key in transaction A 610. When owner 2 transfers the asset to owner 3, a block containing transaction C 630 is formed. The record of transaction C 630 comprises the public key of owner 3 (recipient), a hash of the previous block, and owner 2's signature for the transaction that is signed by owner 2's private key 635 and verified using owner 2's public key from transaction B 620. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 6 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

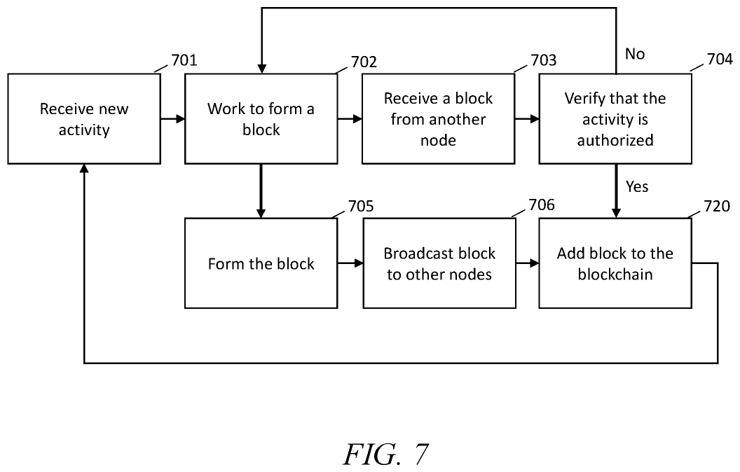

Now referring to FIG. 7, a flow diagram according to some embodiments is shown. In some embodiments, the steps shown in FIG. 7 may be performed by a processor-based device, such as a computer system, a server, a distributed server, a timestamp server, a blockchain node, and the like. In some embodiments, the steps in FIG. 7 may be performed by one or more of the nodes in a system using blockchain for record keeping.

In step 701, a node receives a new activity. The new activity may comprise an update to the record (e.g., security certificate for an automated vehicle or other information) being kept in the form of a blockchain. In some embodiments, for blockchain supported digital or physical asset record keeping, the new activity may comprise an asset transaction. In some embodiments, the new activity may be broadcasted to a plurality of nodes on the network prior to step 701. In step 702, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 702, if the node successfully forms a block in step 705 prior to receiving a block from another node, the node broadcasts the block to other nodes over the network in step 706. In some embodiments, in a system with incentive features, the first node to form a block may be permitted to add incentive payment to itself in the newly formed block. In step 720, the node then adds the block to its copy of the blockchain. In the event that the node receives a block formed by another node in step 703 prior to being able to form the block, the node works to verify that the activity recorded in the received block is authorized in step 704. In some embodiments, the node may further check the new block against system consensus rules for blocks and activities to verify whether the block is properly formed. If the new block is not authorized, the node may reject the block update and return to step 702 to continue to work to form the block. If the new block is verified by the node, the node may express its approval by adding the received block to its copy of the blockchain in step 720. After a block is added, the node then returns to step 701 to form the next block using the newly extended blockchain for the hash in the new block.

In some embodiments, in the event one or more blocks having the same block number is received after step 720, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 701.

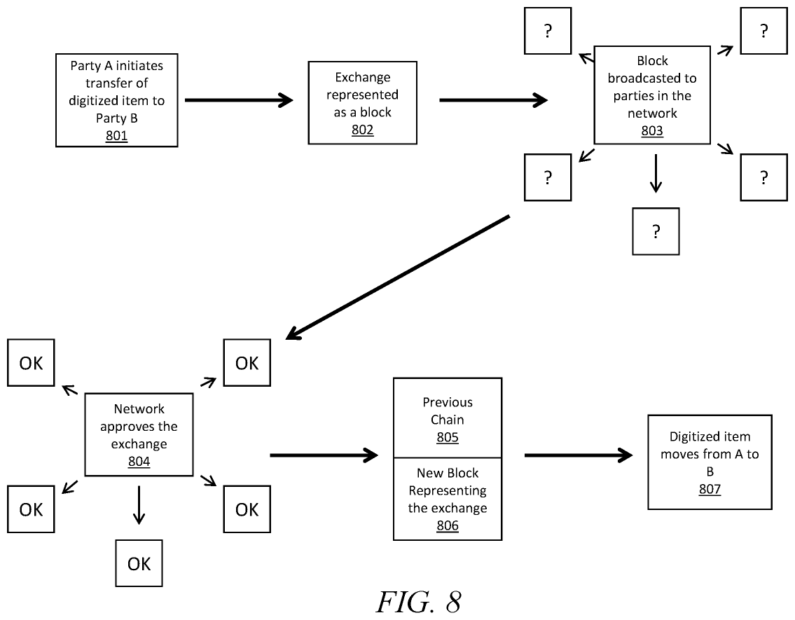

Now referring to FIG. 8, a process diagram a blockchain update according to some implementations in shown. In step 801, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 802, the exchange initiated in step 801 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 803, the block is broadcasted to parties in the network. In step 804, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 806 representing the exchange is added to the existing chain 805 comprising blocks that chronologically precede the new block 806. The new block 806 may contain the transaction(s) and a hash of one or more blocks in the existing chain 805. In some embodiments, each node may then update their copy of the blockchain with the new block and continue to work on extending the chain with additional transactions. In step 807, when the chain is updated with the new block, the digitized item is moved from party A to party B.

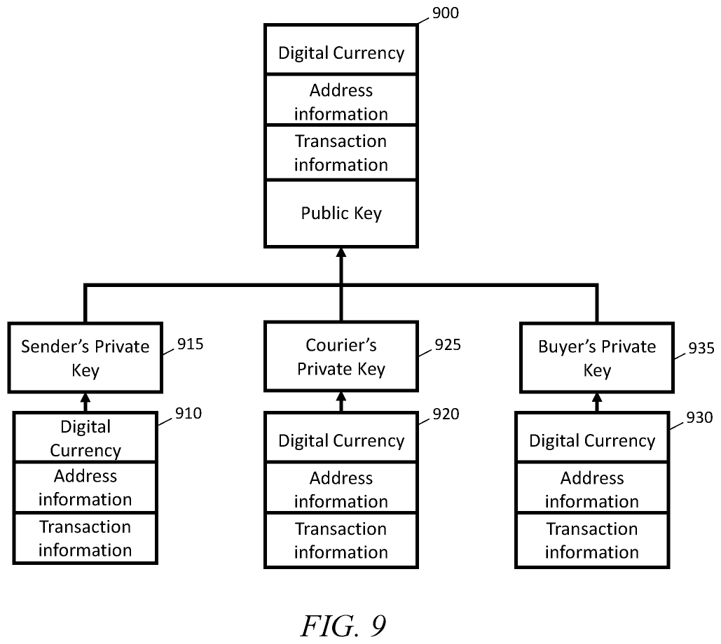

Now referring to FIG. 9, a diagram of a blockchain according to some embodiments is shown. FIG. 9 comprises an example of an implementation of a blockchain system for delivery service record keeping. The delivery record 900 comprises digital currency information, address information, transaction information, and a public key associated with one or more of a sender, a courier, and a buyer. In some embodiments, nodes associated the sender, the courier, and the buyer may each store a copy of the delivery record 910, 920, and 930 respectively. In some embodiments, the delivery record 900 comprises a public key that allows the sender, the courier, and/or the buyer to view and/or update the delivery record 900 using their private keys 915, 925, and the 935 respectively. For example, when a package is transferred from a sender to the courier, the sender may use the sender's private key 915 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 925 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 9, the delivery record may be updated by one or more of the sender, courier, and the buyer to form a record of the transaction without a trusted third party while preventing unauthorized modifications to the record. In some embodiments, the blockchain-based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

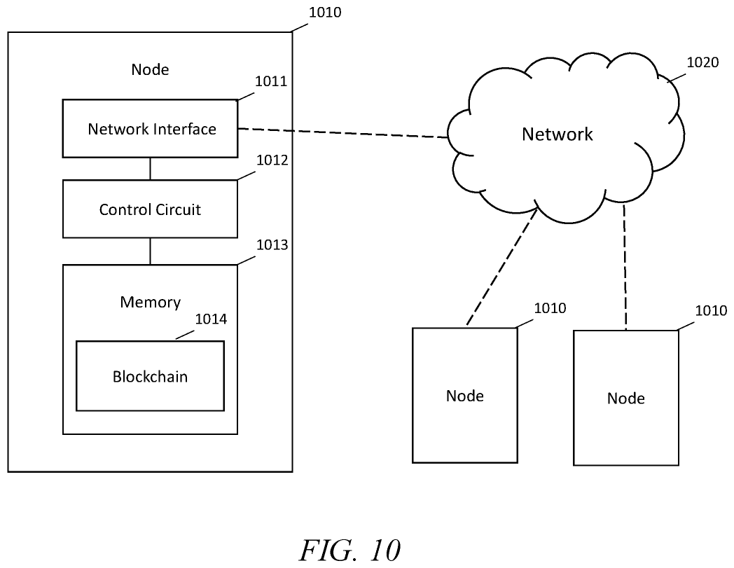

Now referring to FIG. 10, a system according to some embodiments is shown. A distributed blockchain system comprises a plurality of nodes 1010 communicating over a network 1020. In some embodiments, the nodes 1010 may be comprise a distributed blockchain server and/or a distributed timestamp server. In some aspects, the nodes are located at delivery locations and/or automated vehicles. In some embodiments, one or more nodes 1010 may comprise or be similar to a “miner” device on the Bitcoin network. Each node 1010 in the system comprises a network interface 1011, a control circuit 1012, and a memory 1013.

The control circuit 1012 may comprise a processor, a microprocessor, and the like and may be configured to execute computer-readable instructions stored on a computer readable storage memory 1013. The computer-readable storage memory may comprise volatile and/or non-volatile memory and have stored upon it a set of computer readable instructions which, when executed by the control circuit 1012, causes the node 1010 update the blockchain 1014 stored in the memory 1013 based on communications with other nodes 1010 over the network 1020. In some embodiments, the control circuit 1012 may further be configured to extend the blockchain 1014 by processing updates to form new blocks for the blockchain 1014. Generally, each node may store a version of the blockchain 1014, and together, may form a distributed database. In some embodiments, each node 1010 may be configured to perform one or more steps described with reference to FIGS. 7-8 herein.

The network interface 1011 may comprise one or more network devices configured to allow the control circuit to receive and transmit information via the network 1020. In some embodiments, the network interface 1011 may comprise one or more of a network adapter, a modem, a router, a data port, a transceiver, and the like. The network 1020 may comprise a communication network configured to allow one or more nodes 1010 to exchange data. In some embodiments, the network 1020 may comprise one or more of the Internet, a local area network, a private network, a virtual private network, a home network, a wired network, a wireless network, and the like. In some embodiments, the system does not include a central server and/or a trusted third-party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as security certificates of automated vehicles, digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain-based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain-based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, one or more of the exemplary embodiments include one or more localized IoT devices and controllers. As a result, in an exemplary embodiment, the localized IoT devices and controllers can perform most, if not all, of the computational load and associated monitoring and then later asynchronous uploading of data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of data may include a key kernel index summary of the data as created under nominal conditions. In an exemplary embodiment, the kernel encodes relatively recently acquired intermittent data (“KRI”). As a result, in an exemplary embodiment, KM includes a continuously utilized near term source of data, but KRI may be discarded depending upon the degree to which such KM has any value based on local processing and evaluation of such KRI. In an exemplary embodiment, KRI may not even be utilized in any form if it is determined that KM is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernals of data in order to filter out data that may reflect generic background data. In an exemplary embodiment, KRG incrementally sequences all future undefined cached kernals having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to determine whether to accept a delivery of a package from an automated vehicle, the system comprising:
an automated vehicle that includes a package disposed in a storage bay, the automated vehicle delivering the package to a delivery location;
at least one sensor that is disposed at the delivery location and is configured to measure one or more delivery characteristics associated with the delivery, the delivery characteristics relating to one or more of: characteristics relating to movement of the automated vehicle, characteristics relating to identification of the automated vehicle, or characteristics of the package;
a transceiver circuit disposed at the delivery location that is configured to receive security credentials from the automated vehicle;
an authentication and verification device coupled to the sensor and the transceiver circuit, the authentication and verification device being disposed at the delivery location, the authentication and verification device including a control circuit and a data storage device, the data storage device storing a confidence threshold, the confidence threshold being a numerical value that is dynamically adjustable and related to a security level, the data storage device also storing a blockchain ledger that stores acceptable security credentials;
wherein the control circuit is configured to:
perform an analysis of the delivery characteristics;
perform a comparison of the received security credentials to acceptable credentials on the ledger;
based upon the results of the analysis and the comparison, determine a confidence score, the confidence score being a numerical measure of trust in an authentic identity of the automated vehicle;
compare the determined confidence score to the confidence threshold and when the score exceeds the confidence threshold, transmit a message to the automated vehicle allowing the vehicle to deliver the package to the delivery location;
wherein the vehicle responsively delivers the package to the delivery location.

2. The system of claim 1, wherein the characteristics relating to movement of the automated vehicle comprises one or more of a flight path of the automated vehicle, an altitude of the automated vehicle, a velocity of the automated vehicle, or an on-time performance of the automated vehicle.

3. The system of claim 1, wherein the characteristics relating to identification of the automated vehicle relate to an identifier displayed on the automated vehicle.

4. The system of claim 1, wherein the characteristics of the package include whether the package has been paid for by a customer and the delivery route.

5. The system of claim 1, wherein the sensor is a camera, a radar device, or a transceiver circuit.

6. The system of claim 1, wherein the delivery location is a kiosk, a retail store, a warehouse, a distribution center, or a customer residence.

7. The system of claim 1, further comprising a central computer, the central computer disposed at a location remote from the delivery location and configured to receive communications from one or more of the automated vehicle or the delivery location, and to determine whether to allow delivery of the package at the delivery location based at least in part upon the communications.

8. The system of claim 1, wherein the automated vehicle is an aerial drone or an automated ground vehicle.

9. The system of claim 1, wherein the sensed delivery characteristics and the received security credentials are weighted in determining the confidence score.

10. A method for determining whether to accept a delivery of a package from an automated vehicle, the method comprising:
storing a package in a storage bay of an automated vehicle, the automated vehicle delivering the package to a delivery location;
at a sensor that is disposed at the delivery location, measuring one or more delivery characteristics associated with the delivery, the delivery characteristics relating to one or more of: characteristics relating to movement of the automated vehicle, characteristics relating to identification of the automated vehicle, or characteristics of the package;
at a transceiver circuit disposed at the delivery location, receiving security credentials from the automated vehicle;
at an authentication and verification device that is disposed at the delivery location, storing a confidence threshold, the confidence threshold being a numerical value that is dynamically adjustable and related to a security level, the data storage device also storing a blockchain ledger that stores acceptable security credentials;
at the authentication and verification device, performing an analysis of the delivery characteristics, and performing a comparison the received security credentials to acceptable credentials on the ledger;
at the authentication and verification device and based upon the results of the analysis and the comparison, determining a confidence score, the confidence score being a numerical measure of trust in an authentic identity of the automated vehicle, and comparing the determined confidence score to the confidence threshold and when the score exceeds the confidence threshold, transmitting a message to the automated vehicle allowing the vehicle to deliver the package to the delivery location;
wherein the vehicle responsively delivers the package to the delivery location.

11. The method of claim 10, wherein the characteristics relating to movement of the automated vehicle comprises one or more of a flight path of the automated vehicle, an altitude of the automated vehicle, a velocity of the automated vehicle, or an on-time performance of the automated vehicle.

12. The method of claim 10, wherein the characteristics relating to identification of the automated vehicle relate to an identifier displayed on the automated vehicle.

13. The method of claim 10, wherein the characteristics of the package include whether the package has been paid for by a customer and the delivery route.

14. The method of claim 10, wherein the sensor is a camera, a radar device, or a transceiver circuit.

15. The method of claim 10, wherein the delivery location is a kiosk, a retail store, a warehouse, a distribution center, or a customer residence.

16. The method of claim 10, further comprising providing a central computer at a location remote from the delivery location and configuring the central computer to receive communications from one or more of the automated vehicle or the delivery location, and determining whether to allow delivery of the package at the delivery location based at least in part upon the communications.

17. The method of claim 10, wherein the automated vehicle is an aerial drone or an automated ground vehicle.

18. The method of claim 10, wherein the sensed delivery characteristics and the received security credentials are weighted in determining the confidence score.
